(19) United States
(12) Patent Application Publication
(10) Pub. No.: US 2026/0273963 A1
(43) Pub. Date: Sep. 17, 2026

(54) Liquid Ejecting Apparatus

(71) Applicant: SEIKO EPSON CORPORATION, Tokyo (JP)

(72) Inventors: Atsushi UMEDA, Azumino (JP); Yuki KAWAI, Matsumoto (JP)

(21) Appl. No.: 19/561,942

(22) Filed: Mar. 10, 2026

(30) Foreign Application Priority Data
Mar. 11, 2025 (JP) 2025-038269

(51) Int. Cl. B41J 11/00; B41J 29/393; H02M 7/06

(52) U.S. Cl. CPC B41J 11/00242; B41J 29/393; H02M 7/06

(57) ABSTRACT

A liquid ejecting apparatus includes a first heating circuit; a second heating circuit; and a driving power output circuit to which that outputs first driving power to be supplied to the first heating circuit, and second driving power to be supplied to the second heating circuit. The driving power output circuit includes a switching circuit that has a first terminal to which a full-wave rectified signal and a second terminal, and that outputs a switching signal from the second terminal by performing switching at a frequency higher than a frequency of the full-wave rectified signal, a smoothing circuit that smooths the switching signal and outputs a drive supply signal, a first switch circuit that switches whether to output the drive supply signal as first driving power; and a second switch circuit that switches whether to output the drive supply signal as second driving power.

The present application is based on, and claims priority from JP Application Serial Number 2025-038269, filed March 11, 2025, the disclosure of which is hereby incorporated by reference herein in its entirety.

### BACKGROUND

### 1. Technical Field

The present disclosure relates to a liquid ejecting apparatus.

### 2. Related Art

JP-A-2013-163336 discloses a printer (liquid ejecting apparatus) that forms an image on a medium by ejecting liquid onto the medium and that includes a drying device such as a heater.

In a liquid ejecting apparatus having a heater as described in JP-A-2013-163336, a resistance load that includes a nichrome line or the like may be used as the heater that heats a medium. In the liquid ejecting apparatus, when the temperature of the heater is controlled using commercial power supplied from the outside, the power consumption of the heater may greatly change in accordance with the voltage value of the commercial power supplied, and the accuracy of controlling the temperature of the heater may decrease. However, in JP-A-2013-163336, sufficient consideration is not given to this point, and there is room for improvement.

### SUMMARY

According to an aspect of the present disclosure, a liquid ejecting apparatus includes: a transport unit that transports a medium; a print head that ejects liquid onto the medium; a first heating circuit that heats the medium; a second heating circuit that heats the medium; and a driving power output circuit to which an alternating current voltage signal is input and that outputs first driving power to be supplied to the first heating circuit, and second driving power to be supplied to the second heating circuit, wherein the driving power output circuit includes a switching circuit that has a first terminal to which a full-wave rectified signal obtained by performing full-wave rectification on the alternating current voltage signal is input, and a second terminal, and that outputs a switching signal from the second terminal by performing switching at a frequency higher than a frequency of the full-wave rectified signal, a smoothing circuit that smooths the switching signal and outputs a drive supply signal obtained by adjusting an amplitude of the full-wave rectified signal, a first switch circuit that switches whether to output the drive supply signal as the first driving power, and a second switch circuit that switches whether to output the drive supply signal as the second driving power.

### BRIEF DESCRIPTION OF THE DRAWINGS

FIG. 1 is a diagram illustrating a schematic configuration of a liquid ejecting apparatus.

FIG. 2 is a diagram illustrating an example of a functional configuration of the liquid ejecting apparatus.

FIG. 3 is a diagram illustrating a configuration of a heater driving unit.

FIG. 4 is a diagram illustrating an example of an operation of a base drive signal output circuit.

FIG. 5 is a diagram illustrating an example of a method for controlling the temperatures of heaters.

### DESCRIPTION OF EMBODIMENTS

Hereinafter, preferred embodiments of the present disclosure will be described with reference to the drawings. The drawings to be used are for convenience of description. The embodiments described below do not unduly limit the contents of the present disclosure described in the scope of claims. In addition, all configurations described below are not necessarily essential components of the present disclosure.

### 1. Configuration of Liquid Ejecting Apparatus

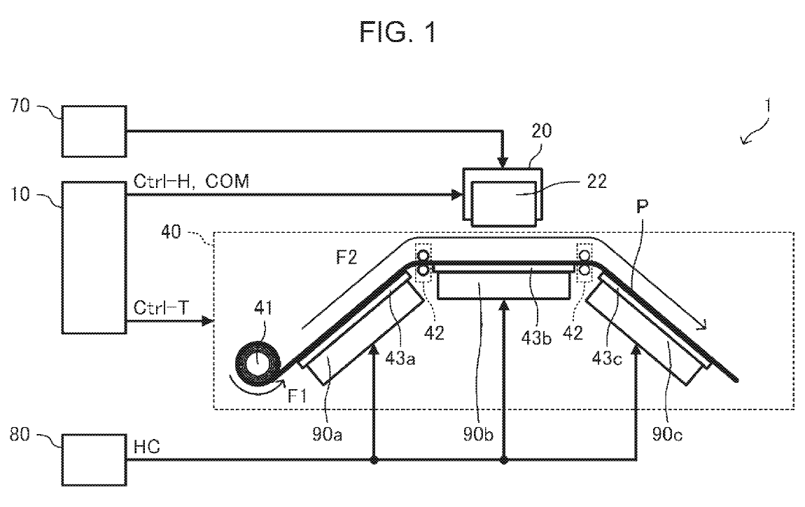

FIG. 1 is a diagram illustrating a schematic configuration of a liquid ejecting apparatus 1. The liquid ejecting apparatus 1 according to the present embodiment is a so-called line printing type ink jet printer in which a head unit 20 includes a plurality of print heads 22 arranged in succession across a length greater than or equal to a width of a medium P and in which each of the plurality of print heads 22 ejects ink onto the medium P transported by a transport unit 40 to form a desired image on the medium P. The liquid ejecting apparatus 1 may be a color material ejecting apparatus that is used for manufacturing a color filter of a liquid crystal display or the like, an electrode material ejecting apparatus that is used for forming an electrode of an organic EL display, a field emission display (FED), or the like, a bio-organic material ejecting apparatus that is used for manufacturing a biochip, a three-dimensional shaping apparatus that generates a three-dimensional object, a textile printing apparatus that dyes a cloth, or the like.

As illustrated in FIG. 1, the liquid ejecting apparatus 1 includes a control unit 10, the head unit 20, the transport unit 40, an ink container 70, a heater driving unit 80, and heaters 90a, 90b, and 90c.

A plurality of types of ink to be ejected onto the medium P are stored in the ink container 70. As the ink container 70, an ink cartridge, a bag-shaped ink pack formed of a flexible film, an ink tank that can be refilled with ink, or the like can be used.

The control unit 10 includes a processing circuit such as a central processing unit (CPU) or a field programmable gate array (FPGA), and a storage circuit such as a semiconductor memory. The control unit 10 generates and outputs a signal for controlling each element of the liquid ejecting apparatus 1 including the head unit 20 in accordance with an image information signal input from an external apparatus.

The head unit 20 includes the plurality of print heads 22. A control signal Ctrl-H and a drive signal COM are output by the control unit 10 and input to each of the plurality of print heads 22. The ink stored in the ink container 70 is supplied to each of the plurality of print heads 22. Each of the plurality of print heads 22 ejects the ink supplied from the ink container 70 onto the medium P, based on the input control signal Ctrl-H and the input drive signal COM.

The transport unit 40 includes a feed motor 41, a plurality of pairs of transport rollers 42, and support members 43a, 43b, and 43c.

The feed motor 41 is rotationally driven in a rotation direction F1 based on a control signal Ctrl-T input from the control unit 10. The medium P is fed by the rotational driving of the feed motor 41 from a roll body around which the medium P is wound in a roll shape.

Each of the plurality of pairs of transport rollers 42 includes a drive roller that is driven based on the control signal Ctrl-T, and a driven roller that is driven in accordance with the driving of the drive roller. Each of the plurality of pairs of transport rollers 42 holds the medium P between the drive roller and the driven roller. When the drive roller is driven based on the control signal Ctrl-T, the medium P held between the drive roller and the driven roller is transported in a transport direction F2.

The support members 43a, 43b, and 43c support the medium P transported in the transport direction F2. Specifically, the support members 43a, 43b, and 43c are positioned in the order of the support member 43a, the support member 43b, and the support member 43c from the upstream side to the downstream side in the transport direction F2. In this case, the support member 43b is positioned to face at least one of the plurality of print heads 22 in a direction in which the ink is ejected from the plurality of print heads 22. That is, the support member 43b functions as a platen that supports the medium P during the ejection of the ink, the support member 43a positioned upstream of the support member 43b supports the medium P before the ink is ejected, and the support member 43c positioned downstream of the support member 43b supports the medium P after the ink is ejected.

The heater driving unit 80 generates a drive signal HC for driving each of the heaters 90a, 90b, and 90c and outputs the drive signal HC to the heaters 90a, 90b, and 90c. Each of the heaters 90a, 90b, and 90c includes a heating element that has a resistance load and that generates heat in accordance with at least one of a voltage value and a current value of the input drive signal HC. The heaters 90a, 90b, and 90c heat the medium P supported by the support members 43a, 43b, and 43c, respectively. Each of the heaters 90a, 90b, and 90c may include a resistance load, such as a nichrome line, as the heating element.

The heater 90a is positioned corresponding to the support member 43a. That is, the heater 90a is positioned upstream of the print heads 22 in the transport direction F2 in a transport path for the medium P transported by the transport unit 40. The medium P supported by the support member 43a is heated by the heater 90a generating heat in response to the drive signal HC. As a result, the possibility that cockling may occur in the medium P onto which the ink is ejected is reduced. The heater 90a may be referred to as a preheater.

The heater 90b is positioned corresponding to the support member 43b. That is, the heater 90b is positioned such that at least a portion of the heater 90b overlaps the print heads 22 as viewed from a direction orthogonal to the transport direction F2 and orthogonal to the transport path for the medium P transported by the transport unit 40. The medium P supported by the support member 43b is heated by the heater 90b generating heat in response to the drive signal HC. As a result, the fixability of the ink ejected onto the medium P is improved, and the possibility that graininess may occur in the image formed on the medium P is reduced. The heater 90b may be referred to as a platen heater.

The heater 90c is positioned corresponding to the support member 43c. That is, the heater 90c is positioned downstream of the print heads 22 in the transport direction F2 in the transport path for the medium P transported by the transport unit 40. The medium P supported by the support member 43c is heated by the heater 90c generating heat in response to the drive signal HC. As a result, the possibility that the ink that has landed on the medium P may be transferred to a rear surface of the medium P is reduced, and the possibility that the medium P may be wrinkled is reduced. The heater 90c may be referred to as an after-heater.

In the liquid ejecting apparatus 1 configured as described above, under control by the control unit 10, the transport unit 40 transports the medium P in the transport direction F2 and the plurality of print heads 22 included in the head unit 20 eject the ink onto the medium P. In this case, the heaters 90a, 90b, and 90c generate heat to heat the medium P under control by the heater driving unit 80, so that the quality of the image formed on the medium P is improved.

In FIG. 1, so-called roll paper wound in a roll shape around the roll body and pulled out from the roll body is used as the medium P as an example, but the medium P may be so-called sheet paper cut into a predetermined size. Further, the heaters 90a, 90b, and 90c and the corresponding support members 43a, 43b, and 43c may be integrally formed. That is, the heaters 90a, 90b, and 90c may also serve as the corresponding support members 43a, 43b, and 43c.

### 2. Functional Configuration of Liquid Ejection Apparatus

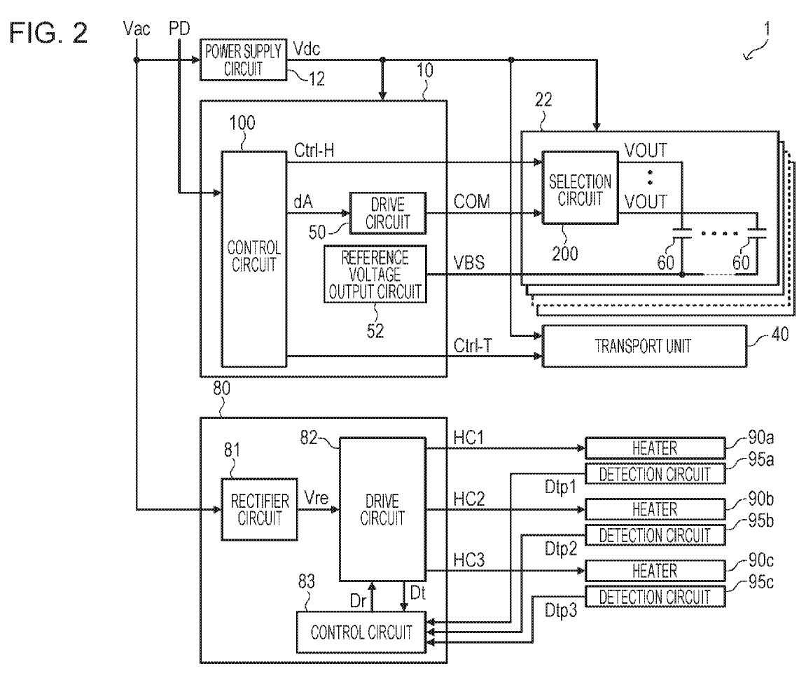

Next, a functional configuration of the liquid ejecting apparatus 1 will be described. FIG. 2 is a diagram illustrating an example of the functional configuration of the liquid ejecting apparatus 1. As illustrated in FIG. 2, the liquid ejecting apparatus 1 includes the control unit 10, a power supply circuit 12, the plurality of print heads 22, the transport unit 40, the heater driving unit 80, the heaters 90a, 90b, and 90c, and detection circuits 95a, 95b, and 95c. The plurality of print heads 22 have the same configuration. Therefore, the following description may focus on one print head 22 among the plurality of print heads 22.

The power supply circuit 12 generates, from a voltage signal Vac that is an alternating current voltage signal of commercial power or the like supplied to the liquid ejecting apparatus 1, a voltage signal Vdc that has a constant voltage of, for example, 42 V and that is a direct current voltage signal that is used in various components including the control unit 10, the plurality of print heads 22, and the transport unit 40 included in the liquid ejecting apparatus 1. The power supply circuit 12 outputs the generated voltage signal Vdc. The power supply circuit 12 includes, for example, an existing AC/DC converter such as a flyback converter. The power supply circuit 12 may output, as the voltage signal Vdc, a direct current voltage signal having a plurality of voltage values that are used in the various components of the liquid ejecting apparatus 1. That is, in addition to the direct current voltage signal having a voltage of 42 V, the power supply circuit 12 may generate a direct current voltage signal having a plurality of voltage values such as 21 V, 7.5 V, 5 V, and 3.3 V, and output the direct current voltage signal as the voltage signal Vdc. In this case, the power supply circuit 12 may include, in addition to the AC/DC converter, one or more DC/DC converters that change the voltage value of the direct current voltage signal output by the AC/DC converter. In the following description, it is assumed that the voltage signal Vac supplied to the liquid ejecting apparatus 1 is an alternating current voltage signal at 50 Hz or 60 Hz, but the frequency of the voltage signal Vac supplied to the liquid ejecting apparatus 1 is not limited thereto.

The control unit 10 includes a drive circuit 50, a reference voltage output circuit 52, and a control circuit 100. The control circuit 100 includes, for example, a processing circuit such as a CPU or an FPGA, and a storage circuit such as a semiconductor memory. An image information signal including image data or the like is input to the control circuit 100 from an external apparatus coupled to the liquid ejecting apparatus 1, and the voltage signal Vdc is input to the control circuit 100. The control circuit 100 is driven by the input voltage signal Vdc as driving power, generates various signals for controlling the liquid ejecting apparatus 1, based on the input image information signal, and outputs the generated signals to corresponding components of the liquid ejecting apparatus 1.

Specifically, the control circuit 100 generates, based on the input image information signal, the control signal Ctrl-T for controlling the transport of the medium P, and outputs the control signal Ctrl-T to the transport unit 40. The transport unit 40 is driven by the voltage signal Vdc as driving power and operates in response to the input control signal Ctrl-T to transport the medium P in the transport direction F2.

In addition, the control circuit 100 generates, based on the input image information signal and the transport position of the medium P, the control signal Ctrl-H for controlling the timing of ejecting the ink from the print head 22, and outputs the control signal Ctrl-H to the corresponding print head 22.

Further, the control circuit 100 outputs, to the drive circuit 50, a base drive signal dA that is a digital signal. The drive circuit 50 performs digital-to-analog signal conversion to convert the input base drive signal dA into an analog signal, then performs class-D amplification on the converted analog signal based on the voltage signal Vdc to generate the drive signal COM, and outputs the drive signal COM to the print head 22. The drive circuit 50 may generate a plurality of drive signals COM corresponding to the plurality of respective print heads 22 and output the drive signals COM to the corresponding print heads 22, or may generate a drive signal COM common to the plurality of print heads 22 and output the drive signal COM to the plurality of print heads 22. Further, the drive circuit 50 may be configured to generate a drive signal COM by performing class-A amplification, class-B amplification, or class-AB amplification instead of or in addition to class-D amplification as long as the drive circuit 50 can amplify a signal waveform defined by the base drive signal dA. Further, the base drive signal dA may be an analog signal as long as the base drive signal dA defines the signal waveform of the drive signal COM.

The reference voltage output circuit 52 generates a voltage signal VBS by stepping down or stepping up the voltage value of the voltage signal Vdc, and outputs the voltage signal VBS to the print head 22. The voltage signal VBS is a signal having a reference electrical potential for driving piezoelectric elements 60 (described later) included in the print head 22, and may be, for example, a direct current voltage signal having a constant electrical potential of 5.5 V, 6 V, or the like.

The print head 22 includes a selection circuit 200 and the plurality of piezoelectric elements 60. The control signal Ctrl-H and the drive signal COM are input to the selection circuit 200. The selection circuit 200 generates, based on the control signal Ctrl-H, a drive signal VOUT corresponding to each of the plurality of piezoelectric elements 60 by selecting or not selecting the signal waveform included in the drive signal COM for each of the plurality of piezoelectric elements 60. Then, the selection circuit 200 supplies each of the generated drive signals VOUT to one end of a corresponding one of the piezoelectric elements 60. Further, the voltage signal VBS is commonly supplied to the other ends of the plurality of piezoelectric elements 60. In this case, each of the plurality of piezoelectric elements 60 is deformed according to a difference in electrical potential between the drive signal VOUT input to the one end and the voltage signal VBS input to the other end. Ink in an amount corresponding to the amount of the deformation of each of the piezoelectric elements 60 is ejected from a nozzle corresponding to the piezoelectric element 60. That is, ink in an amount corresponding to the amount of the deformation of each of the piezoelectric elements 60 is ejected from the print head 22.

The voltage signal Vac is input to the heater driving unit 80. The heater driving unit 80 generates drive signals HC1, HC2, and HC3 as drive signals HC from the input voltage signal Vac, and outputs the drive signals HC1, HC2, and HC3 to the heaters 90a, 90b, and 90c, respectively.

The drive signal HC1 as the drive signal HC is input to the heater 90a. The heater 90a generates heat in accordance with at least one of a voltage value and a current value of the input drive signal HC1. The drive signal HC2 as the drive signal HC is input to the heater 90b. The heater 90b generates heat in accordance with at least one of a voltage value and a current value of the input drive signal HC2. The drive signal HC3 as the drive signal HC is input to the heater 90c. The heater 90c generates heat in accordance with at least one of a voltage value and a current value of the input drive signal HC3.

The detection circuit 95a is positioned near the heater 90a and detects the temperature of the heater 90a. Then, the detection circuit 95a generates a detection signal Dtp1 corresponding to the temperature of the heater 90a and outputs the detection signal Dtp1 to the heater driving unit 80. The detection circuit 95b is positioned near the heater 90b and detects the temperature of the heater 90b. The detection circuit 95b generates a detection signal Dtp2 corresponding to the temperature of the heater 90b and outputs the detection signal Dtp2 to the heater driving unit 80. The detection circuit 95c is positioned near the heater 90c and detects the temperature of the heater 90c. The detection circuit 95c generates a detection signal Dtp3 corresponding to the temperature of the heater 90c and outputs the detection signal Dtp3 to the heater driving unit 80. Each of the detection circuits 95a, 95b, and 95c may include a circuit element whose characteristics change according to the temperature and that is, for example, a thermistor element or the like.

The heater driving unit 80 includes a rectifier circuit 81, a drive circuit 82, and a control circuit 83.

The voltage signal Vac input to the heater driving unit 80 is input to the rectifier circuit 81. The rectifier circuit 81 generates a voltage signal Vre by performing full-wave rectification on the voltage signal Vac, and outputs the voltage signal Vre to the drive circuit 82. The voltage signal Vre output by the rectifier circuit 81 is not limited to the signal obtained by performing the full-wave rectification on the voltage signal Vac, and may be a signal obtained by performing half-wave rectification on the voltage signal Vac. The detection signals Dtp1, Dtp2, and Dtp3 input to the heater driving unit 80 are input to the control circuit 83. A state signal Dt indicating a driving state of the drive circuit 82 is input to the control circuit 83. The control circuit 83 generates a drive control signal Dr corresponding to the input detection signals Dtp1, Dtp2, and Dtp3 and the input state signal Dt and outputs the drive control signal Dr to the drive circuit 82. The drive circuit 82 generates the drive signals HC1, HC2, and HC3 as the drive signals HC in accordance with the voltage signal Vre input from the rectifier circuit 81 and the drive control signal Dr input from the control circuit 83, and outputs the drive signals HC1, HC2, and HC3 from the heater driving unit 80.

In the heater driving unit 80 configured as described above, the drive circuit 82 generates the drive signal HC1 for controlling the temperature of the heater 90a, based on the detection signal Dtp1 corresponding to the temperature of the heater 90a, generates the drive signal HC2 for controlling the temperature of the heater 90b, based on the detection signal Dtp2 corresponding to the temperature of the heater 90b, and generates the drive signal HC3 for controlling the temperature of the heater 90c, based on the detection signal Dtp3 corresponding to the temperature of the heater 90c. Therefore, the temperature of each of the heaters 90a, 90b, and 90c can be individually controlled to a desired temperature. Details of the configuration and operation of the heater driving unit 80 will be described later.

As described above, the liquid ejecting apparatus 1 according to the present embodiment includes the transport unit 40 that transports the medium P, the print head 22 that ejects ink onto the medium P, the heaters 90a, 90b, and 90c that heat the medium P, the heater driving unit 80 to which the voltage signal Vac is input and that outputs the drive signal HC1 to be supplied to the heater 90a, the drive signal HC2 to be supplied to the heater 90b, and the drive signal HC3 to be supplied to the heater 90c, and the power supply circuit 12 that generates, from the voltage signal Vac, the voltage signal Vdc that is a direct current voltage signal to be supplied to the transport unit 40.

### 3. Configuration and Operation of Heater Driving Unit

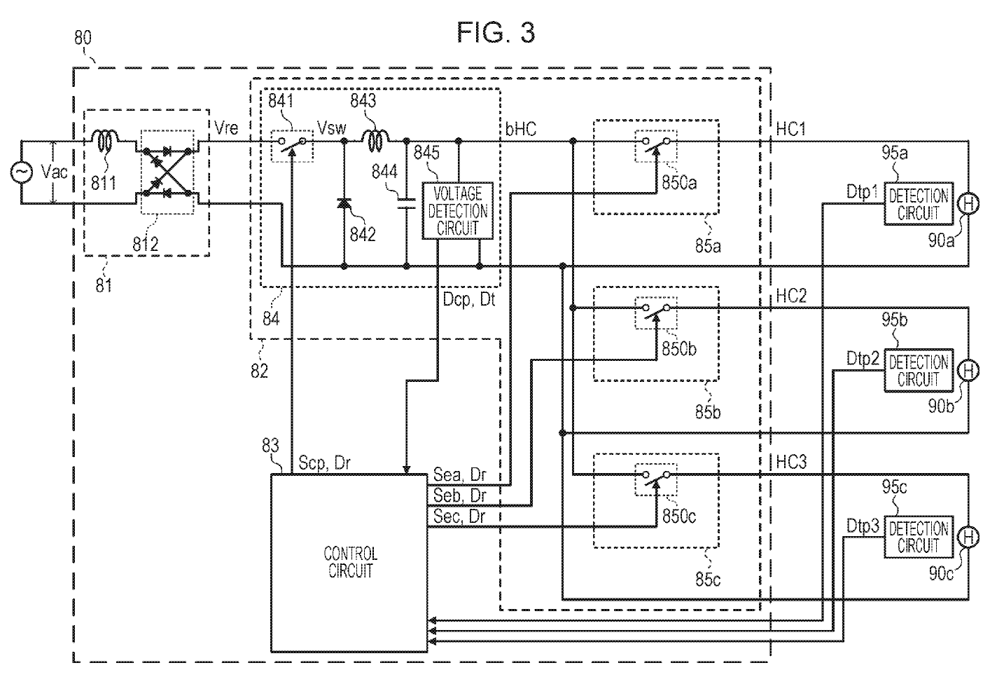

FIG. 3 is a diagram illustrating a configuration of the heater driving unit 80. As described above, the heater driving unit 80 includes the rectifier circuit 81, the drive circuit 82, and the control circuit 83. FIG. 3 illustrates, in addition to the configuration of the heater driving unit 80, the heaters 90a to 90c to which the drive signals HC1 to HC3 output by the heater driving unit 80 are supplied, and the detection circuits 95a to 95c that output the detection signals Dtp1 to Dtp3 corresponding to the temperatures of the heaters 90a to 90c.

The rectifier circuit 81 includes an inductor 811 and a diode bridge 812. The voltage signal Vac supplied to the liquid ejecting apparatus 1 is supplied to one end of the inductor 811 and one input terminal of the diode bridge 812. The other end of the inductor 811 is electrically coupled to the other input terminal of the diode bridge 812. The diode bridge 812 generates the voltage signal Vre by performing the full-wave rectification on the input voltage signal Vac, and outputs the voltage signal Vre from a positive-side output terminal. In this case, an electrical potential of a negative-side output terminal of the diode bridge 812 serves as a reference electrical potential for the operation of the heater driving unit 80.

The inductor 811 included in the rectifier circuit 81 functions as a normal filter that reduces normal mode noise superimposed on the voltage signal Vac. This improves the accuracy of the waveform of the voltage signal Vre output by the rectifier circuit 81. The rectifier circuit 81 may include an inductor element such as a line filter that reduces the common mode noise superimposed on the voltage signal Vac, instead of the inductor 811 or in addition to the inductor 811.

The drive circuit 82 includes a base drive signal output circuit 84 and switch circuits 85a, 85b, and 85c. The base drive signal output circuit 84 includes a switch element 841, a diode 842, an inductor 843, a capacitor 844, and a voltage detection circuit 845.

The switch element 841 includes, for example, an n-channel FET element. The voltage signal Vre is input to a drain terminal of the switch element 841 that is a first terminal of the switch element 841. A control signal Scp as a drive control signal Dr output by the control circuit 83 is input to a gate terminal of the switch element 841 that is a control terminal of the switch element 841. A source terminal of the switch element 841 that is a second terminal of the switch element 841 is electrically coupled to a cathode terminal of the diode 842 and one end of the inductor 843. The other end of the inductor 843 is electrically coupled to one end of the capacitor 844. The reference electrical potential for the heater driving unit 80 is supplied to an anode terminal of the diode 842 and the other end of the capacitor 844. Then, the base drive signal output circuit 84 outputs, as a base drive signal bHC, a voltage value of a node where the other end of the inductor 843 and the one end of the capacitor 844 are electrically coupled to each other.

In addition, one end of the voltage detection circuit 845 is electrically coupled to the node where the other end of the inductor 843 and the one end of the capacitor 844 are electrically coupled to each other and through which the base drive signal bHC is propagated. The reference electrical potential for the heater driving unit 80 is supplied to the other end of the voltage detection circuit 845. The voltage detection circuit 845 detects the voltage value of the base drive signal bHC based on a difference in electrical potential between the base drive signal bHC propagating through the node to which the one end of the voltage detection circuit 845 is coupled and the reference electrical potential for the heater driving unit 80 supplied to the other end of the voltage detection circuit 845. The voltage detection circuit 845 generates a detection signal Dcp corresponding to the result of the detection. Specifically, the voltage detection circuit 845 includes a peak hold circuit in which a voltage held in each period of the voltage signal Vre is reset, and acquires the maximum voltage value of the base drive signal bHC in each period of the voltage signal Vre. The maximum value of the base drive signal bHC in each period of the voltage signal Vre is the voltage held in the peak hold circuit in each period of the voltage signal Vre. Then, the voltage detection circuit 845 generates the detection signal Dcp corresponding to the acquired value, and outputs, as a state signal Dt, the generated detection signal Dcp to the control circuit 83. The configuration of the voltage detection circuit 845 is not limited to the configuration including the peak hold circuit, and the voltage detection circuit 845 may be configured to acquire an average value or an effective value of the voltage value of the base drive signal bHC in each period of the voltage signal Vre.

In addition, the diode 842 included in the base drive signal output circuit 84 functions as a regeneration diode that regenerates a current when a signal based on the base drive signal bHC is supplied to the heaters 90a, 90b, and 90c and a current flowing through the capacitor 844. Thus, the stability of the operation of the base drive signal output circuit 84 is improved.

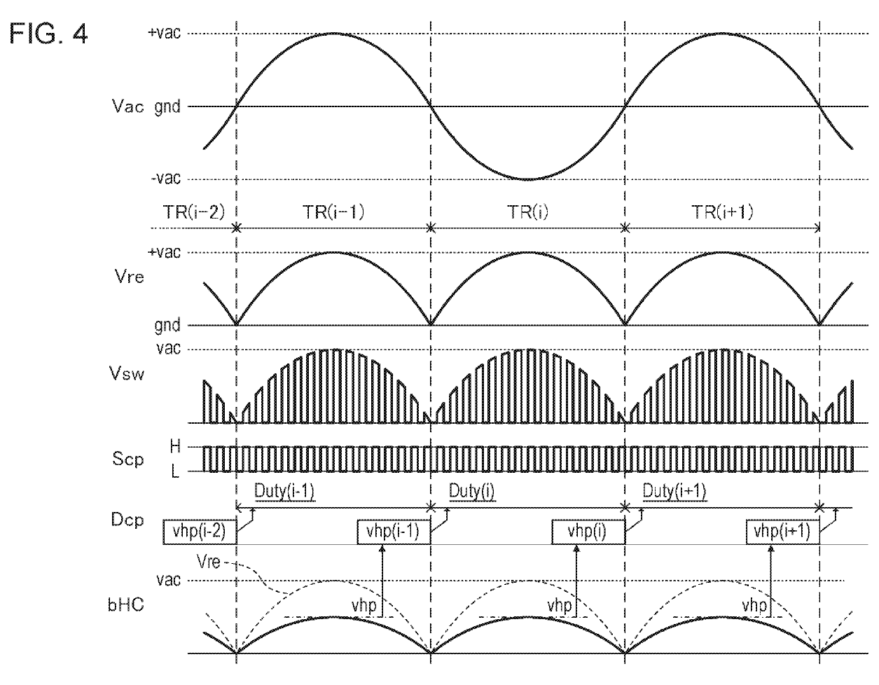

The operation of the base drive signal output circuit 84 will be described. FIG. 4 is a diagram illustrating an example of the operation of the base drive signal output circuit 84. FIG. 4 illustrates a full-wave period TR[i] (i is any natural number) as any period, a full-wave period TR[i - 1] immediately before the full-wave period TR[i], and a full-wave period TR[i + 1] immediately after the full-wave period TR[i] as full-wave periods TR that are periods of the voltage signal Vre input to the base drive signal output circuit 84. For example, the full-wave period TR is a period that repeats approximately every 10 ms in a case where the voltage signal Vac is at a frequency of 50 Hz, and is a period that repeats approximately every 8.3 ms in a case where the voltage signal Vac is at a frequency of 60 Hz. In the following description, it is assumed that the first terminal and the second terminal of the switch element 841 are controlled to be conductive when an H-level control signal Scp is input to the control terminal of the switch element 841, and that the first terminal and the second terminal of the switch element 841 are controlled to be non-conductive when an L-level control signal Scp is input to the control terminal of the switch element 841. The relationship between the conduction state of the switch element 841 and the logic level of the control signal Scp is not limited to the above-described relationship.

As illustrated in FIG. 4, the rectifier circuit 81 generates the voltage signal Vre whose voltage value changes between +vac [V] and the reference electrical potential for the heater driving unit 80 by performing the full-wave rectification on the voltage signal Vac that is an alternating current voltage signal and whose voltage value changes between +vac [V] and -vac [V]. The voltage signal Vre generated by the rectifier circuit 81 is input to the first terminal of the switch element 841 of the base drive signal output circuit 84.

The switch element 841 switches whether to output, from the second terminal, the voltage signal Vre supplied to the first terminal as a voltage signal Vsw in accordance with the logic level of the control signal Scp input to the control terminal. In this case, the frequency of the control signal Scp input to the control terminal of the switch element 841 is sufficiently higher than the frequency of the voltage signal Vre and is set to a frequency of several kHz or higher. That is, the switch element 841 is driven at a switching frequency of several kHz or higher. Therefore, at the second terminal of the switch element 841, the voltage signal Vsw having a signal waveform in which the voltage signal Vre is shaped into a comb shape in accordance with the frequency of the control signal Scp as illustrated in FIG. 4 is generated. In other words, the voltage signal Vre obtained by performing the full-wave rectification on the voltage signal Vac is input to the first terminal of the switch element 841, and the switch element 841 outputs the voltage signal Vsw from the second terminal by performing switching at a frequency higher than the frequency of the voltage signal Vre.

The voltage signal Vsw is supplied to the one end of the inductor 843. As described above, the other end of the inductor 843 is electrically coupled to the one end of the capacitor 844, and the reference electrical potential for the heater driving unit 80 is supplied to the other end of the capacitor 844. That is, the inductor 843 and the capacitor 844 constitute a low-pass filter circuit. The voltage signal Vsw output by the switch element 841 is smoothed by the low-pass filter circuit including the inductor 843 and the capacitor 844. In this case, the cutoff frequency of the low-pass filter circuit is set to be higher than the frequency of the voltage signal Vre and lower than the frequency of the control signal Scp. Specifically, in a case where the frequency of the control signal Scp is 20 kHz, the cutoff frequency of the low-pass filter circuit including the inductor 843 and the capacitor 844 is set to a frequency of approximately 10 kHz. In a case where the frequency of the control signal Scp is 50 kHz, the cutoff frequency of the low-pass filter circuit including the inductor 843 and the capacitor 844 is set to a frequency of approximately 30 kHz to 40 kHz. Therefore, a signal obtained by smoothing the voltage signal Vsw having the comb shape, that is, by changing the voltage amplitude of the voltage signal Vre is generated at the node that is an output of the low-pass filter circuit constituted by the inductor 843 and the capacitor 844 and where the other end of the inductor 843 and the one end of the capacitor 844 are electrically coupled to each other. That is, the low-pass filter circuit including the inductor 843 and the capacitor 844 outputs the base drive signal bHC obtained by adjusting the amplitude of the voltage signal Vre, and the base drive signal output circuit 84 including the low-pass filter circuit including the inductor 843 and the capacitor 844 outputs the signal obtained by changing the voltage amplitude of the voltage signal Vre as the base drive signal bHC.

In this case, the voltage detection circuit 845 acquires the maximum voltage value of the base drive signal bHC in each full-wave period TR, generates a detection signal Dcp corresponding to the acquired maximum voltage value of the base drive signal bHC, and outputs the detection signal Dcp to the control circuit 83. The control circuit 83 controls, in accordance with the input detection signal Dcp, the on-duty of the control signal Scp to be output. Specifically, the control circuit 83 acquires the maximum voltage value vhp of the base drive signal bHC in the full-wave period TR[i - 1] as a voltage vhp(i - 1) based on the detection signal Dcp input in the full-wave period TR[i - 1]. Then, in a case where the voltage value of the acquired voltage vhp(i - 1) is greater than a target voltage value, the control circuit 83 sets the on-duty of the control signal Scp to be output in the full-wave period TR[i] to be less than the on-duty of the control signal Scp output in the full-wave period TR[i - 1]. As a result, the maximum voltage value of the base drive signal bHC in the full-wave period TR[i] becomes less than the maximum voltage value of the base drive signal bHC in the full-wave period TR[i - 1]. On the other hand, in a case where the voltage value of the obtained voltage vhp(i - 1) is less than the target voltage value, the control circuit 83 sets the on-duty of the control signal Scp to be output in the full-wave period TR[i] to be greater than the on-duty of the control signal Scp output in the full-wave period TR[i - 1]. As a result, the maximum voltage value of the base drive signal bHC in the full-wave period TR[i] becomes greater than the maximum voltage value of the base drive signal bHC in the full-wave period TR[i - 1].

That is, the heater driving unit 80 includes the control circuit 83 that controls the switching of the switch element 841, and the control circuit 83 controls the duty ratio of the switching of the switch element 841 in accordance with the input detection signal Dcp that is the voltage value of the base drive signal bHC. Then, the control circuit 83 controls, in accordance with the input detection signal Dcp, the on-duty of the control signal Scp to be output, and thus the base drive signal output circuit 84 outputs the base drive signal bHC controlled such that the maximum voltage value of the base drive signal bHC is substantially constant at the target voltage value regardless of the voltage amplitude of the voltage signal Vac supplied to the liquid ejecting apparatus 1 and the voltage amplitude of the voltage signal Vre output by the rectifier circuit 81. In this case, the frequency of the base drive signal bHC output by the base drive signal output circuit 84 is substantially equal to the frequency of the voltage signal Vre output by the rectifier circuit 81, and the maximum voltage value of the base drive signal bHC is less than the maximum voltage value of the voltage signal Vre.

The control circuit 83 may determine the on-duty of the control signal Scp to be output, by PID control based on a result of comparison between the maximum voltage value of the base drive signal bHC acquired based on the detection signal Dcp in each full-wave period TR and the target voltage value.

The base drive signal output circuit 84 configured as described above can output the base drive signal bHC controlled to a predetermined voltage value regardless of the voltage value of the input voltage signal Vac. Therefore, the possibility that the amounts of electric power supplied to the heaters 90a, 90b, and 90c, which are loads, may vary in accordance with the voltage value of the input voltage signal Vac is reduced, and as a result, the accuracy of controlling the temperatures of the heaters 90a, 90b, and 90c is improved.

On the other hand, as a circuit that outputs a signal controlled to a predetermined voltage value regardless of the voltage value of the input voltage signal Vac, for example, a switching power supply type AC/DC converter that is used in the power supply circuit 12 and has a configuration using a flyback circuit or a buck converter circuit may be used. However, in a case where a switching power supply type AC/DC converter circuit, such as a flyback circuit or a buck converter circuit, is used as the base drive signal output circuit 84, a smoothing circuit capable of smoothing the frequency of a signal obtained by performing full-wave rectification on input commercial power is required, and a capacitor element having a large capacitance is required to implement such a smoothing circuit. Therefore, in a case where a switching power supply type AC/DC converter circuit, such as a flyback circuit or a buck converter circuit, is used as the circuit that outputs the signal controlled to the predetermined voltage value regardless of the voltage value of the input voltage signal Vac, a countermeasure circuit for reducing a harmonic current needs to be separately provided, which causes a problem of an increase in circuit size.

In the base drive signal output circuit 84 according to the present embodiment, the low-pass filter circuit including the inductor 843 and the capacitor 844 can adjust the amplitude of the voltage signal Vre obtained by performing the full-wave rectification on the voltage signal Vac that is commercial power. Therefore, the capacitance of the capacitor 844 can be reduced, and it is not necessary to separately provide a countermeasure circuit for reducing a harmonic current. That is, in the base drive signal output circuit 84 according to the present embodiment, it is possible to make the capacitance of the capacitor 844 included in the low-pass filter circuit in the base drive signal output circuit 84 less than the capacitance of a capacitor included in the power supply circuit 12. As a result, it is not necessary to separately provide a countermeasure circuit for reducing a harmonic current, and it is possible to make the base drive signal output circuit 84 compact.

Returning to FIG. 3, the base drive signal bHC output by the base drive signal output circuit 84 is input to the switch circuits 85a, 85b, and 85c.

The switch circuit 85a includes a switch element 850a. The base drive signal bHC is supplied to a first terminal of the switch element 850a. A control signal Sea as a drive control signal Dr output by the control circuit 83 is input to a control terminal of the switch element 850a. Then, the switch circuit 85a outputs, as the drive signal HC1, a voltage value at a second terminal of the switch element 850a to the heater 90a. As the switch element 850a, for example, a triac element, an FET, an IGBT element, or the like can be used.

In the switch circuit 85a configured as described above, the conduction state of the switch element 850a is controlled based on the control signal Sea output by the control circuit 83. Thus, the switch circuit 85a switches whether to output the base drive signal bHC as the drive signal HC1. In this case, a voltage value of the base drive signal bHC supplied to the first terminal of the switch circuit 85a is controlled to be substantially constant. Therefore, at least one of the amounts of voltage and current that are to be supplied to the heater 90a by the drive signal HC1 is controlled based on the control signal Sea output by the control circuit 83. In other words, the temperature of the heater 90a, that is, the amount of heat generated by the heater 90a, is controlled by the control signal Sea output by the control circuit 83.

In the following description, it is assumed that the first terminal and the second terminal of the switch element 850a are controlled to be conductive when an H-level control signal Sea is input to the control terminal of the switch element 850a, and that the first terminal and the second terminal of the switch element 850a are controlled to be non-conductive when an L-level control signal Sea is input to the control terminal of the switch element 850a. The relationship between the conduction state between the first terminal and the second terminal of the switch element 850a and the logic level of the control signal Sea is not limited thereto.

The switch circuit 85b includes a switch element 850b. The base drive signal bHC is supplied to a first terminal of the switch element 850b. A control signal Seb as a drive control signal Dr output by the control circuit 83 is input to a control terminal of the switch element 850b. Then, the switch circuit 85b outputs, as the drive signal HC2, a voltage value at a second terminal of the switch element 850b to the heater 90b. As the switch element 850b, for example, a triac element, an FET, an IGBT element, or the like can be used.

In the switch circuit 85b configured as described above, the conduction state of the switch element 850b is controlled based on the control signal Seb output by the control circuit 83. Thus, the switch circuit 85b switches whether to output the base drive signal bHC as the drive signal HC2. In this case, a voltage value of the base drive signal bHC supplied to the first terminal of the switch circuit 85b is controlled to be substantially constant. Therefore, at least one of the amounts of voltage and current that are to be supplied to the heater 90b by the drive signal HC2 is controlled based on the control signal Seb output by the control circuit 83. In other words, the temperature of the heater 90b, that is, the amount of heat generated by the heater 90b, is controlled by the control signal Seb output by the control circuit 83.

In the following description, it is assumed that the first terminal and the second terminal of the switch element 850b are controlled to be conductive when an H-level control signal Seb is input to the control terminal of the switch element 850b, and that the first terminal and the second terminal of the switch element 850b are controlled to be non-conductive when an L-level control signal Seb is input to the control terminal of the switch element 850b. The relationship between the conduction state between the first terminal and the second terminal of the switch element 850b and the logic level of the control signal Seb is not limited thereto.

The switch circuit 85c includes a switch element 850c. The base drive signal bHC is supplied to a first terminal of the switch element 850c. A control signal Sec as a drive control signal Dr output by the control circuit 83 is input to a control terminal of the switch element 850c. Then, the switch circuit 85c outputs, as the drive signal HC3, a voltage value at a second terminal of the switch element 850c to the heater 90c. As the switch element 850c, for example, a triac element, an FET, an IGBT element, or the like can be used.

In the switch circuit 85c configured as described above, the conduction state of the switch element 850c is controlled based on the control signal Sec output by the control circuit 83. Thus, the switch circuit 85c switches whether to output the base drive signal bHC as the drive signal HC3. In this case, a voltage value of the base drive signal bHC supplied to the first terminal of the switch circuit 85c is controlled to be substantially constant. Therefore, at least one of the amounts of voltage and current that are to be supplied to the heater 90c by the drive signal HC3 is controlled based on the control signal Sec output by the control circuit 83. In other words, the temperature of the heater 90c, that is, the amount of heat generated by the heater 90c, is controlled by the control signal Sec output by the control circuit 83.

In the following description, it is assumed that the first terminal and the second terminal of the switch element 850c are controlled to be conductive when an H-level control signal Sec is input to the control terminal of the switch element 850c, and that the first terminal and the second terminal of the switch element 850c are controlled to be non-conductive when an L-level control signal Sec is input to the control terminal of the switch element 850c. The relationship between the conduction state between the first terminal and the second terminal of the switch element 850c and the logic level of the control signal Sec is not limited thereto.

The control circuit 83 controls the temperature of the heater 90a by controlling the on-duty of the control signal Sea in each of temperature control periods TM that are predetermined periods of time, controls the temperature of the heater 90b by controlling the on-duty of the control signal Seb in each of the temperature control periods TM that are the predetermined periods of time, and controls the temperature of the heater 90c by controlling the on-duty of the control signal Sec in each of the temperature control periods TM that are the predetermined periods of time. That is, the control circuit 83 controls the amount of heat to be generated by each of the heaters 90a, 90b, and 90c and the temperature of each of the heaters 90a, 90b, and 90c.

The plurality of temperature control periods TM in which the control circuit 83 controls the temperatures of the heaters 90a, 90b, and 90c are all periods of the same time length, and are set to be sufficiently longer than the full-wave period TR that is the period of the voltage signal Vre. The plurality of temperature control periods TM are set to be, for example, longer than or equal to 1 second, and preferably approximately 1.5 seconds.

A specific example of a method for controlling the temperatures of the heaters 90a, 90b, and 90c will be described. The control circuit 83 according to the present embodiment controls at least one of the amounts of voltage and current that are to be supplied to the heater 90a as the drive signal HC1, at least one of the amounts of voltage and current that are supplied to the heater 90b as the drive signal HC2, and at least one of the amounts of voltage and current that are to be supplied to the heater 90c as the drive signal HC3, by controlling the on-duty of the control signals Sea, Seb, and Sec to be output in each of the temperature control periods TM. Thus, the control circuit 83 controls the temperatures of the heaters 90a, 90b, and 90c in each of the temperature control periods TM. That is, the temperatures of the heaters 90a, 90b, and 90c are controlled by the control circuit 83 in each of the temperature control periods TM.

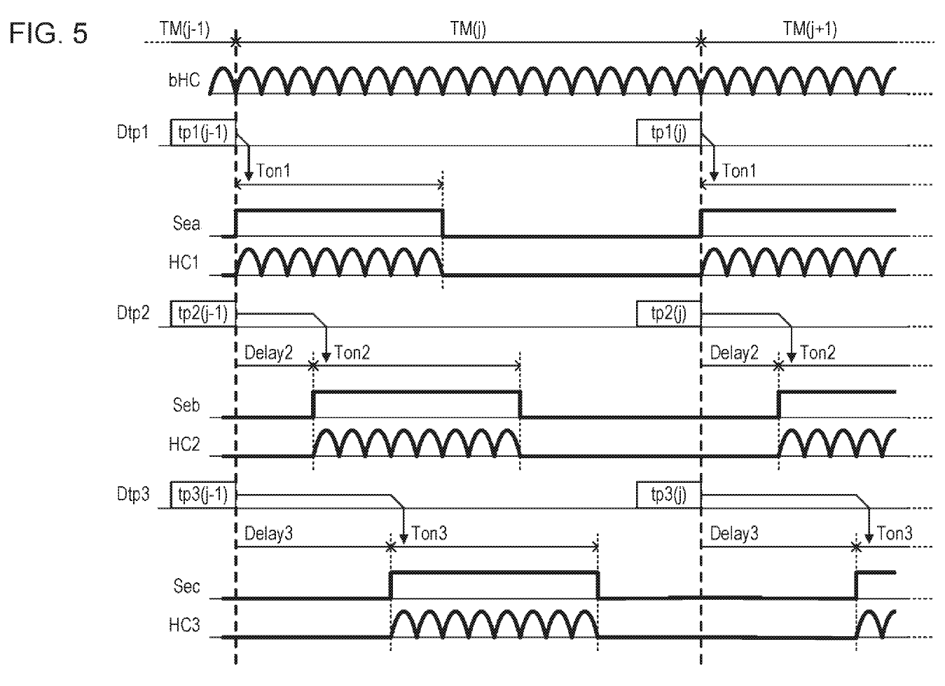

FIG. 5 is a diagram illustrating an example of a method for controlling the temperatures of the heaters 90a, 90b, and 90c. FIG. 5 illustrates any temperature control period TM[j] (j is any natural number) as a temperature control period TM that is a period for controlling the temperatures of the heaters 90a, 90b, and 90c. Further, in the following description, a temperature control period TM immediately before the temperature control period TM[j] may be referred to as a temperature control period TM[j - 1], and a temperature control period TM immediately after the temperature control period TM[j] may be referred to as a temperature control period TM[j + 1].

The control circuit 83 acquires temperature information tp1[j - 1] corresponding to the temperature of the heater 90a in the temperature control period TM[j - 1] from the detection signal Dtp1 input in the temperature control period TM[j - 1]. Then, the control circuit 83 calculates, based on the acquired temperature information tp1[j - 1], a period of time ton1 for outputting the H-level control signal Sea, that is, the on-duty of the control signal Sea in the temperature control period TM[j]. Thereafter, the control circuit 83 sets the logic level of the control signal Sea to be output to an H level at the timing of the transition to the temperature control period TM[j] and sets the logic level of the control signal Sea to be output to an L level at a timing when the period of time ton1 elapses from the start of the output of the H-level control signal Sea.

Specifically, in a case where the temperature of the heater 90a indicated in the acquired temperature information tp1[j - 1] is higher than a target temperature, the control circuit 83 calculates the period of time ton1 that causes the on-duty of the control signal Sea to be output in the temperature control period TM[j] to be less than the on-duty of the control signal Sea output in the temperature control period TM[j - 1]. As a result, the amounts of voltage and current that are to be supplied to the heater 90a in the temperature control period TM[j] decrease and become less than the amounts of voltage and current supplied to the heater 90a in the temperature control period TM[j - 1]. Therefore, the temperature of the heater 90a in the temperature control period TM[j] decreases toward the target temperature. On the other hand, in a case where the temperature of the heater 90a indicated in the acquired temperature information tp1[j - 1] is lower than the target temperature, the control circuit 83 calculates the period of time ton1 that causes the on-duty of the control signal Sea to be output in the temperature control period TM[j] to be greater than the on-duty of the control signal Sea output in the temperature control period TM[j - 1]. As a result, the amounts of voltage and current that are to be supplied to the heater 90a in the temperature control period TM[j] increase and become greater than the amounts of voltage and current supplied to the heater 90a in the temperature control period TM[j - 1]. Therefore, the temperature of the heater 90a in the temperature control period TM[j] rises toward the target temperature.

The control circuit 83 acquires temperature information tp2[j - 1] corresponding to the temperature of the heater 90b in the temperature control period TM[j - 1] from the detection signal Dtp2 input in the temperature control period TM[j - 1]. Then, the control circuit 83 calculates, based on the acquired temperature information tp2[j - 1], a period of time ton2 for outputting the H-level control signal Seb, that is, the on-duty of the control signal Seb in the temperature control period TM[j]. Thereafter, the control circuit 83 shifts to the temperature control period TM[j], sets the logic level of the control signal Seb to be output to an H level at a timing when a delay time period Delay2 elapses, and sets the logic level of the control signal Seb to be output to an L level at a timing when the period of time ton2 elapses from the start of the output of the H-level control signal Seb.

Specifically, in a case where the temperature of the heater 90b indicated in the acquired temperature information tp2[j - 1] is higher than a target temperature, the control circuit 83 calculates the period of time ton2 that causes the on-duty of the control signal Seb to be output in the temperature control period TM[j] to be less than the on-duty of the control signal Seb output in the temperature control period TM[j - 1]. As a result, the amounts of voltage and current that are to be supplied to the heater 90b in the temperature control period TM[j] decrease and become less than the amounts of voltage and current supplied to the heater 90b in the temperature control period TM[j - 1]. Therefore, the temperature of the heater 90b in the temperature control period TM[j] decreases toward the target temperature. On the other hand, in a case where the temperature of the heater 90b indicated in the acquired temperature information tp2[j - 1] is lower than the target temperature, the control circuit 83 calculates the period of time ton2 that causes the on-duty of the control signal Seb to be output in the temperature control period TM[j] to be greater than the on-duty of the control signal Seb output in the temperature control period TM[j - 1]. As a result, the amounts of voltage and current that are to be supplied to the heater 90b in the temperature control period TM[j] increase and become greater than the amounts of voltage and current supplied to the heater 90b in the temperature control period TM[j - 1]. Therefore, the temperature of the heater 90b in the temperature control period TM[j] rises toward the target temperature.

The control circuit 83 acquires temperature information tp3[j - 1] corresponding to the temperature of the heater 90c in the temperature control period TM[j - 1] from the detection signal Dtp3 input in the temperature control period TM[j - 1]. Then, the control circuit 83 calculates, based on the acquired temperature information tp3[j - 1], a period of time ton3 for outputting the H-level control signal Sec, that is, the on-duty of the control signal Sec in the temperature control period TM[j]. Thereafter, the control circuit 83 shifts to the temperature control period TM[j], sets the logic level of the control signal Sec to be output to an H level at a timing when a delay time period Delay3 elapses, and sets the logic level of the control signal Sec to be output to an L level at a timing when the period of time ton3 elapses from the start of the output of the H-level control signal Sec.

Specifically, in a case where the temperature of the heater 90c indicated in the acquired temperature information tp3[j - 1] is higher than a target temperature, the control circuit 83 calculates the period of time ton3 that causes the on-duty of the control signal Sec to be output in the temperature control period TM[j] to be less than the on-duty of the control signal Sec output in the temperature control period TM[j - 1]. As a result, the amounts of voltage and current that are to be supplied to the heater 90c in the temperature control period TM[j] decrease and become less than the amounts of voltage and current supplied to the heater 90c in the temperature control period TM[j - 1]. Therefore, the temperature of the heater 90c in the temperature control period TM[j] decreases toward the target temperature. On the other hand, in a case where the temperature of the heater 90c indicated in the acquired temperature information tp3[j - 1] is lower than the target temperature, the control circuit 83 calculates the period of time ton3 that causes the on-duty of the control signal Sec to be output in the temperature control period TM[j] to be greater than the on-duty of the control signal Sec output in the temperature control period TM[j - 1]. As a result, the amounts of voltage and current that are to be supplied to the heater 90c in the temperature control period TM[j] increase and become greater than the amounts of voltage and current supplied to the heater 90c in the temperature control period TM[j - 1]. Therefore, the temperature of the heater 90c in the temperature control period TM[j] rises toward the target temperature.

As described above, the control circuit 83 controls the on-duty of the control signal Sea to be output, in accordance with the input detection signal Dtp1, controls the on-duty of the control signal Seb to be output, in accordance with the input detection signal Dtp2, and controls the on-duty of the control signal Sec to be output, in accordance with the input detection signal Dtp3, thereby controlling the temperatures of the heaters 90a, 90b, and 90c to be closer to or equal to the respective target temperatures. The control circuit 83 may determine the on-duty of the control signals Sea, Seb, and Sec to be output, by PID control based on results of comparison between the temperatures of the heaters 90a, 90b, and 90c acquired based on the detection signals Dtp1, Dtp2, and Dtp3 in each of the temperature control periods TM and the target temperatures. Thus, the possibility that the temperatures of the heaters 90a, 90b, and 90c may overshoot or undershoot is reduced, and the accuracy of controlling the temperatures of the heaters 90a, 90b, and 90c is improved.

As described above, the heater driving unit 80 includes the switch circuit 85a that switches whether to output the base drive signal bHC as the drive signal HC1 to be supplied to the heater 90a, the switch circuit 85b that switches whether to output the base drive signal bHC as the drive signal HC2 to be supplied to the heater 90b, the switch circuit 85c that switches whether to output the base drive signal bHC as the drive signal HC3 to be supplied to the heater 90c, and the control circuit 83 that controls the switch circuits 85a, 85b, and 85c. The control circuit 83 controls, in accordance with the temperature of the heater 90a, switching of whether to output the base drive signal bHC as the drive signal HC1 in the switch circuit 85a, controls, in accordance with the temperature of the heater 90b, switching of whether to output the base drive signal bHC as the drive signal HC2 in the switch circuit 85b, and controls, in accordance with the temperature of the heater 90c, switching of whether to output the base drive signal bHC as the drive signal HC3 in the switch circuit 85c. Thus, the temperatures of the heaters 90a, 90b, and 90c are controlled to be closer to or equal to the respective target temperatures. In this case, since the voltage values of the base drive signal bHC that are input to the switch circuits 85a, 85b, and 85c and are output as the drive signals HC1, HC2, and HC3 by the switch circuits 85a, 85b, and 85c are controlled to be substantially constant regardless of the voltage value of the input voltage signal Vac, the control circuit 83 can control the temperatures of the heaters 90a, 90b, and 90c with high accuracy.

In the liquid ejecting apparatus 1 according to the present embodiment, the control circuit 83 delays a timing when the switch circuit 85b starts outputting the base drive signal bHC as the drive signal HC2 by the delay time period Delay2 relative to a timing when the switch circuit 85a starts outputting the base drive signal bHC as the drive signal HC1, and delays a timing when the switch circuit 85c starts outputting the base drive signal bHC as the drive signal HC3 by the delay time period Delay3 relative to the timing when the switch circuit 85a starts outputting the base drive signal bHC as the drive signal HC1. That is, the control circuit 83 controls the switch circuits 85a, 85b, and 85c such that a timing when the switch circuit 85a switches whether to output the base drive signal bHC as the drive signal HC1, a timing when the switch circuit 85b switches whether to output the base drive signal bHC as the drive signal HC2, and a timing when the switch circuit 85c switches whether to output the base drive signal bHC as the drive signal HC3 are different from each other.

An inrush current is generated at each of the timing when the switch circuit 85a starts outputting the base drive signal bHC as the drive signal HC1, the timing when the switch circuit 85b starts outputting the base drive signal bHC as the drive signal HC2, and the timing when the switch circuit 85c starts outputting the base drive signal bHC as the drive signal HC3. Therefore, the control circuit 83 controls the switch circuits 85a, 85b, and 85c such that the timing when the switch circuit 85a switches whether to output the base drive signal bHC as the drive signal HC1, the timing when the switch circuit 85b switches whether to output the base drive signal bHC as the drive signal HC2, and the timing when the switch circuit 85c switches whether to output the base drive signal bHC as the drive signal HC3 are different from each other, thereby dispersing the effect of the inrush currents. As a result, the possibility that the signal waveform of the voltage signal Vac may be distorted is reduced. Therefore, even in a case where another electronic apparatus is coupled to a power supply system from which the voltage signal Vac is supplied to the liquid ejecting apparatus 1, the possibility that the operations of the heaters 90a, 90b, and 90c may contribute to the other electronic apparatus is reduced.

It is preferable that the control circuit 83 switch whether the switch circuit 85a outputs the base drive signal bHC as the drive signal HC1, switch whether the switch circuit 85b outputs the base drive signal bHC as the drive signal HC2, and switch whether the switch circuit 85c outputs the base drive signal bHC as the drive signal HC3, at a timing when the voltage value of the voltage signal Vac crosses zero and when the voltage value of the voltage signal Vre becomes a bottom voltage. That is, it is preferable that the timing when the switch circuit 85a switches whether to output the base drive signal bHC as the drive signal HC1, the timing when the switch circuit 85b switches whether to output the base drive signal bHC as the drive signal HC2, and the timing when the switch circuit 85c switches whether to output the base drive signal bHC as the drive signal HC3 be synchronized with the timing when the voltage value of the voltage signal Vre becomes the bottom voltage. Thus, it is possible to reduce the possibility that noise caused by a switching operation may be superimposed on the drive signal HC1 output by the switch circuit 85a, the drive signal HC2 output by the switch circuit 85b, and the drive signal HC3 output by the switch circuit 85c, and it is also possible to reduce the possibility that the above-described inrush currents may be generated. As a result, the temperatures of the heaters 90a, 90b, and 90c can be controlled with higher accuracy.

A capacitor included in a smoothing circuit included in an AC/DC converter serving as the power supply circuit 12 is an example of a first smoothing capacitor. Any one of the heaters 90a,90b, and 90c is an example of a first heating circuit, and another one of the heaters 90a, 90b, and 90c is an example of a second heating circuit. The heater driving unit 80 is an example of a driving power output circuit. The switch element 841 is an example of a switching circuit. The low-pass filter circuit including the inductor 843 and the capacitor 844 is an example of a smoothing circuit. The capacitor 844 is an example of a second smoothing capacitor. The control circuit 83 is an example of a switching control circuit and a switch control circuit. The voltage signal Vac is an example of an alternating current voltage signal. The voltage signal Vdc is an example of a direct current voltage signal. The voltage signal Vre is an example of a full-wave rectified signal. The voltage signal Vsw is an example of a switching signal. The base drive signal bHC is an example of a drive supply signal. Any one of the drive signals HC1, HC2, and HC3 is an example of first driving power, and another one of the drive signals HC1, HC2, and HC3 is an example of second driving power.

### 4. Operations and Effects

In the liquid ejecting apparatus 1 according to the present embodiment configured as described above, the base drive signal output circuit 84 included in the heater driving unit 80 includes the switch element 841 that has the first terminal to which the voltage signal Vre obtained by performing the full-wave rectification on the voltage signal Vac is input, and the second terminal, and that outputs the voltage signal Vsw from the second terminal by performing switching at a frequency higher than the frequency of the voltage signal Vre, and the low-pass filter circuit that includes the inductor 843 and the capacitor 844 and that outputs the base drive signal bHC obtained by adjusting the amplitude of the voltage signal Vre. In the base drive signal output circuit 84, the low-pass filter circuit may smooth the voltage signal Vsw output by the switch element 841 to the extent that the base drive signal bHC obtained by adjusting the amplitude of the voltage signal Vre can be output. Therefore, the capacitance of the capacitor 844 included in the low-pass filter circuit can be reduced. Therefore, the base drive signal output circuit 84 included in the heater driving unit 80 can output the base drive signal bHC controlled to the predetermined voltage value regardless of the voltage value of the input voltage signal Vac without providing a circuit for reducing a harmonic current.

In the liquid ejecting apparatus 1 according to the present embodiment, the heater driving unit 80 includes the switch circuit 85a that switches whether to output, as the drive signal HC1, the base drive signal bHC output by the base drive signal output circuit 84, the switch circuit 85b that switches whether to output, as the drive signal HC2, the base drive signal bHC output by the base drive signal output circuit 84, and the switch circuit 85c that switches whether to output, as the drive signal HC3, the base drive signal bHC output by the base drive signal output circuit 84. Thus, whether to supply the base drive signal bHC to each of the heaters 90a, 90b, and 90c is individually controlled. In this case, since the voltage value of the base drive signal bHC is controlled to the predetermined voltage value regardless of the voltage value of the input voltage signal Vac, the accuracy of controlling the temperatures of the heaters 90a, 90b, and 90c can be improved.

That is, in the liquid ejecting apparatus 1 according to the present embodiment, the heater driving unit 80 includes the switch element 841 that has the first terminal to which the voltage signal Vre obtained by performing the full-wave rectification on the voltage signal Vac is input, and the second terminal, and that outputs the voltage signal Vsw from the second terminal by performing switching at a frequency higher than the frequency of the voltage signal Vre, the low-pass filter circuit that includes the inductor 843 and the capacitor 844 and that outputs the base drive signal bHC obtained by adjusting the amplitude of the voltage signal Vre, the switch circuit 85a that switches whether to output, as the drive signal HC1, the base drive signal bHC output by the base drive signal output circuit 84, the switch circuit 85b that switches whether to output, as the drive signal HC2, the base drive signal bHC output by the base drive signal output circuit 84, and the switch circuit 85c that switches whether to output, as the drive signal HC3, the base drive signal bHC output by the base drive signal output circuit 84. Therefore, even when the voltage value of the voltage signal Vac changes, the possibility that the accuracy of controlling the temperatures of the heaters 90a, 90b, and 90c may decrease is reduced while the possibility of increasing the circuit size is reduced.

While the embodiments and the modifications are described above, the present disclosure is not limited to the embodiments and can be implemented in various aspects without departing from the concept of the present disclosure. For example, the above-described embodiments can also be combined with each other as appropriate.

The present disclosure includes substantially the same configurations (for example, configurations having the same functions, methods, and results as those described above, or configurations that achieve the same purposes and effects as those described above) as the configurations described in the embodiments. The present disclosure also includes configurations obtained by replacing non-essential sections of the configurations described in the embodiments. The present disclosure also includes configurations that achieve the same operations and effects as those of the configurations described in the embodiments or configurations that can achieve the same purposes as those of the configurations described in the embodiments. The present disclosure also includes configurations obtained by adding a known technology to the configurations described in the embodiments.

The following contents are derived from the above-described embodiments.

A liquid ejecting apparatus according to an aspect includes: a transport unit that transports a medium; a print head that ejects liquid onto the medium; a first heating circuit that heats the medium; a second heating circuit that heats the medium; and a driving power output circuit to which an alternating current voltage signal is input and that outputs first driving power to be supplied to the first heating circuit, and second driving power to be supplied to the second heating circuit, wherein the driving power output circuit includes a switching circuit that has a first terminal to which a full-wave rectified signal obtained by performing full-wave rectification on the alternating current voltage signal is input, and a second terminal, and that outputs a switching signal from the second terminal by performing switching at a frequency higher than a frequency of the full-wave rectified signal, a smoothing circuit that smooths the switching signal and outputs a drive supply signal obtained by adjusting an amplitude of the full-wave rectified signal, a first switch circuit that switches whether to output the drive supply signal as the first driving power, and a second switch circuit that switches whether to output the drive supply signal as the second driving power.

According to the liquid ejecting apparatus, since the driving power output circuit includes the switching circuit that has the first terminal to which the full-wave rectified signal obtained by performing the full-wave rectification on the alternating current voltage signal is input, and the second terminal, and that outputs the switching signal from the second terminal by performing switching at a frequency higher than the frequency of the full-wave rectified signal, and the smoothing circuit that smooths the switching signal and outputs the drive supply signal obtained by adjusting the amplitude of the full-wave rectified signal, it is possible to output the drive supply signal controlled to a predetermined voltage value regardless of the voltage value of the input alternating current voltage signal without providing a circuit for reducing a harmonic current. Further, since the driving power output circuit includes the first switch circuit that switches whether to output the drive supply signal as the first driving power and the second switch circuit that switches whether to output the drive supply signal as the second driving power, it is possible to individually control whether to supply the drive supply signal to each of the first heating circuit and the second heating circuit. In this case, since the voltage value of the drive supply signal input to each of the first switch circuit and the second switch circuit is controlled to a predetermined voltage value regardless of the voltage value of the input alternating current voltage signal, it is possible to improve the accuracy of controlling the temperature of the first heating circuit and the temperature of the second heating circuit.

That is, according to the liquid ejecting apparatus, even in a case where the voltage value of the alternating current voltage signal supplied from the outside changes, the possibility that the accuracy of controlling the temperature of the first heating circuit and the temperature of the second heating circuit may decrease can be reduced while the possibility of increasing the circuit size is reduced.

In the liquid ejecting apparatus according to the aspect, the smoothing circuit may include a low-pass filter circuit, and a cutoff frequency of the low-pass filter circuit may be higher than the frequency of the full-wave rectified signal and lower than a frequency of the switching signal.

According to the liquid ejecting apparatus, it is possible to reduce the capacitance of a capacitor of the smoothing circuit that outputs the drive supply signal obtained by adjusting the amplitude of the full-wave rectified signal. Therefore, the possibility that the voltage value of the drive supply signal may fluctuate due to a fluctuation in the voltage value of the input alternating current voltage signal is further reduced.

In the liquid ejecting apparatus according to the aspect, a frequency of the drive supply signal may be substantially equal to the frequency of the full-wave rectified signal, and a maximum voltage value of the drive supply signal may be less than a maximum voltage value of the full-wave rectified signal.

In the liquid ejecting apparatus according to the aspect, the driving power output circuit may include a switching control circuit that controls the switching of the switching circuit, and the switching control circuit may control a duty ratio of the switching of the switching circuit in accordance with a voltage value of the drive supply signal.

According to the liquid ejecting apparatus, it is possible to improve the accuracy of controlling the voltage value of the drive supply signal.

In the liquid ejecting apparatus according to the aspect, the driving power output circuit may include a switch control circuit that controls the first switch circuit and the second switch circuit, and the switch control circuit may control, in accordance with a temperature of the first heating circuit, the switching of whether to output the drive supply signal as the first driving power in the first switch circuit, and may control, in accordance with a temperature of the second heating circuit, the switching of whether to output the drive supply signal as the second driving power in the second switch circuit.

In the liquid ejecting apparatus according to the aspect, a timing when the first switch circuit switches whether to output the drive supply signal as the first driving power and a timing when the second switch circuit switches whether to output the drive supply signal as the second driving power may be synchronized with a timing when a voltage value of the full-wave rectified signal becomes a bottom voltage.

According to the liquid ejecting apparatus, the possibility that noise may be superimposed on the first driving power output by the first switch circuit and the second driving power output by the second switch circuit is reduced, and the possibility that the accuracy of controlling the temperature of the first heating circuit and the temperature of the second heating circuit may decrease is further reduced.

In the liquid ejecting apparatus according to the aspect, a timing when the first switch circuit switches whether to output the drive supply signal as the first driving power may be different from a timing when the second switch circuit switches whether to output the drive supply signal as the second driving power.

According to the liquid ejecting apparatus, since the timing when the first switch circuit switches whether to output the drive supply signal as the first driving power and the timing when the second switch circuit switches whether to output the drive supply signal as the second driving power are different, an inrush current at a timing when the supply of the first driving power to the first heating circuit is started and an inrush current at a timing when the supply of the second driving power to the second heating circuit is started are dispersed. As a result, the possibility that the signal waveform of the alternating current voltage signal supplied to the liquid ejecting apparatus may be distorted due to the inrush currents is reduced. Therefore, even in a case where another electronic apparatus is coupled to a power supply system from which the alternating current voltage signal is supplied to the liquid ejecting apparatus, the possibility that the operations of the first heating circuit and the second heating circuit may contribute to the other electronic apparatus is reduced.

In the liquid ejecting apparatus according to the aspect, at least one of the first heating circuit and the second heating circuit may be positioned upstream of the print head and along a transport path for the medium transported by the transport unit.

In the liquid ejecting apparatus according to the aspect, the first heating circuit and the second heating circuit may be positioned such that at least a portion of at least one of the first heating circuit and the second heating circuit overlaps the print head as viewed from a direction orthogonal to a transport path for the medium transported by the transport unit.

In the liquid ejecting apparatus according to the aspect, at least one of the first heating circuit and the second heating circuit may be positioned downstream of the print head and along a transport path for the medium transported by the transport unit.

The liquid ejecting apparatus according to the aspect may further include a power supply circuit that generates, from the alternating current voltage signal, a direct current voltage signal to be supplied to the transport unit, wherein the power supply circuit may include a first smoothing capacitor, the smoothing circuit may include a second smoothing capacitor, and a capacitance of the second smoothing capacitor may be less than a capacitance of the first smoothing capacitor.

What is claimed is:

1. A liquid ejecting apparatus comprising:
a transport unit that transports a medium;
a print head that ejects liquid onto the medium;
a first heating circuit that heats the medium;
a second heating circuit that heats the medium; and
a driving power output circuit to which an alternating current voltage signal is input and that outputs first driving power to be supplied to the first heating circuit, and second driving power to be supplied to the second heating circuit, wherein
the driving power output circuit includes
a switching circuit that has a first terminal to which a full-wave rectified signal obtained by performing full-wave rectification on the alternating current voltage signal is input, and a second terminal, and that outputs a switching signal from the second terminal by performing switching at a frequency higher than a frequency of the full-wave rectified signal,
a smoothing circuit that smooths the switching signal and outputs a drive supply signal obtained by adjusting an amplitude of the full-wave rectified signal,
a first switch circuit that switches whether to output the drive supply signal as the first driving power, and
a second switch circuit that switches whether to output the drive supply signal as the second driving power.

2. The liquid ejecting apparatus according to claim 1, wherein
the smoothing circuit includes a low-pass filter circuit, and
a cutoff frequency of the low-pass filter circuit is higher than the frequency of the full-wave rectified signal and lower than a frequency of the switching signal.

3. The liquid ejecting apparatus according to claim 1, wherein
a frequency of the drive supply signal is substantially equal to the frequency of the full-wave rectified signal, and
a maximum voltage value of the drive supply signal is less than a maximum voltage value of the full-wave rectified signal.

4. The liquid ejecting apparatus according to claim 1, wherein
the driving power output circuit includes a switching control circuit that controls the switching of the switching circuit, and
the switching control circuit controls a duty ratio of the switching of the switching circuit in accordance with a voltage value of the drive supply signal.

5. The liquid ejecting apparatus according to claim 1, wherein
the driving power output circuit includes a switch control circuit that controls the first switch circuit and the second switch circuit, and
the switch control circuit
controls, in accordance with a temperature of the first heating circuit, the switching of whether to output the drive supply signal as the first driving power in the first switch circuit, and
controls, in accordance with a temperature of the second heating circuit, the switching of whether to output the drive supply signal as the second driving power in the second switch circuit.

6. The liquid ejecting apparatus according to claim 1, wherein
a timing when the first switch circuit switches whether to output the drive supply signal as the first driving power and a timing when the second switch circuit switches whether to output the drive supply signal as the second driving power are synchronized with a timing when a voltage value of the full-wave rectified signal becomes a bottom voltage.

7. The liquid ejecting apparatus according to claim 1, wherein
a timing when the first switch circuit switches whether to output the drive supply signal as the first driving power is different from a timing when the second switch circuit switches whether to output the drive supply signal as the second driving power.

8. The liquid ejecting apparatus according to claim 1, wherein
at least one of the first heating circuit and the second heating circuit is positioned upstream of the print head and along a transport path for the medium transported by the transport unit.

9. The liquid ejecting apparatus according to claim 1, wherein
the first heating circuit and the second heating circuit are positioned such that at least a portion of at least one of the first heating circuit and the second heating circuit overlaps the print head as viewed from a direction orthogonal to a transport path for the medium transported by the transport unit.

10. The liquid ejecting apparatus according to claim 1, wherein
at least one of the first heating circuit and the second heating circuit is positioned downstream of the print head and along a transport path for the medium transported by the transport unit.

11. The liquid ejecting apparatus according to claim 1, further comprising:
a power supply circuit that generates, from the alternating current voltage signal, a direct current voltage signal to be supplied to the transport unit, wherein
the power supply circuit includes a first smoothing capacitor,
the smoothing circuit includes a second smoothing capacitor,
a capacitance of the second smoothing capacitor is less than a capacitance of the first smoothing capacitor.
